(19) United States
(12) Patent Application Publication
(10) Pub. No.: US 2006/0093838 A1
(43) Pub. Date: May 4, 2006

(54) Metal coated substrate and manufacturing method of the same

(75) Inventors: Shuichi Kohayashi, Tokyo (JP); Akio Sawabe, Tokyo (JP); Yukihiro Kitamura, Tokyo (JP)

Correspondence Address: OLIFF & BERRIDGE, PLC, P.O. BOX 19928, ALEXANDRIA, VA, 22320, US

(73) Assignee: Dowa Mining Co., Ltd., Tokyo (JP)

(21) Appl. No.: 11/230,528

(22) Filed: Sep. 21, 2005

(30) Foreign Application Priority Data
Oct. 29, 2004 (JP) 2004-316702

(51) Int. Cl. B32B 15/08

(52) U.S. Cl. 428/457; 427/248.1; 427/96.1

(57) ABSTRACT

A metal substrate having high strength and stability of adhesion between a metal film and a plastic film, wherein the metal film can be made thin. The plastic film as a base is placed inside a device for applying a silane coupling agent and is dried at a temperature of 300° C., after which the vaporized silane coupling agent is blown onto the plastic film while the temperature is maintained at 300° C., and the surface of the plastic film is coated with the silane coupling agent. A film of copper is formed by sputtering on the surface of the plastic film thus coated with the coupling agent, and the plastic film provided with the sputtered copper film is coated with a glossy copper coating having the desired thickness using a plating method.

### BACKGROUND OF THE INVENTION

1. Field of the Invention

The present invention relates to a metal-coated substrate used in a flexible circuit board, a flexible wiring board, a TAB tape, or the like; and to a manufacturing method thereof.

2. Description of the Related Art

A metal-coated substrate in which a plastic film is coated with a metal film is a necessary material for high-density packaging of mobile telephones, digital cameras, or other electronic devices in which a circuit is formed in the coated portion, and an IC, capacitor, or other microchip is mounted on the circuit.

Copper is most widely used as the metal film of the metal-coated substrate from the perspective of cost, workability, electrical characteristics, migration resistance, and other characteristics. Various plastic films are used in the substrate material according to the application of the metal-coated substrate, but since a high degree of thermal dimensional stability is sought in such cases as when a microchip is soldered onto a conductive circuit in a metal film that is machined with high precision, a thermally stable polyimide film having a small difference in its linear expansion coefficient with respect to the metal layer is preferred for use.

The following and other methods are used as manufacturing methods for these metal-coated substrates:

(1) A method whereby a copper foil is fabricated in advance using a rolling method or electrolytic method, and the copper foil is joined to a plastic film by an adhesive;

(2) A casting method whereby a plastic film precursor is applied on a copper film and polymerized, and the copper foil and plastic film are bonded together without the use of an adhesive (see JP-A 60-157286, for example);

(3) A lamination method whereby a thermoplastic film and a copper foil are layered and laminated, and the copper foil and plastic film are bonded together (see U.S. Pat. No. 4,543,295, for example);

(4) A vapor deposition plating method whereby a plastic film is coated with a thin metal layer by sputtering or the like, and the coating metal layer is coated by a plating method with a metal plating layer to a prescribed thickness (see JP-A 61-47015, for example); and

(5) A vapor deposition plating method whereby a plastic film is dipped into a solution of a silane compound that is a coupling agent (a compound that is effective in joining an inorganic substance with an organic substance), and the surface of the plastic film is modified, after which the modified plastic film is coated with a thin metal layer by sputtering or the like, and the coating metal layer is coated by a plating method with a metal plating layer to a prescribed thickness (see JP-A 2002-4067, for example).

Since metal-coated substrates manufactured by the aforementioned casting method (2), lamination method (3), and other methods that do not use an adhesive have excellent adhesion at relatively high temperatures, they are widely used in such applications as mounting chip components. However, the requirements of high-density mounting have significantly increased in conjunction with recent technological advances, and the need is increasing for creating even thinner metal coatings for responding to an increased preciseness of the circuits.

In order to satisfy the aforementioned requirements, the plastic film is formed by casting, or the plastic film and the copper foil are layered and laminated in the casting method or the lamination method, by using a thinner copper foil as much as possible. However, the process of fabricating a thin copper foil and bonding the thin copper foil thus fabricated has limitations. For example, even when a copper foil having a thickness of 9 μm or less is fabricated by electrolysis or rolling, there is a problem that the copper foil has poor handling properties during a bonding process, and wrinkling and the like occur in the copper foil.

A method whereby a thick copper foil is bonded in advance to a plastic film, and the copper foil is thinned in a later process by chemical etching or the like, or a method whereby a buffer layer is pre-laminated in the copper layer, and thinning of the copper layer is accomplished by peeling or the like of the buffer layer after lamination of the copper layer is employed for the purpose of enhancing handling properties and preventing the occurrence of wrinkles and the like (see JP-A 2001-30847, for example).

A plastic film can be coated by a relatively low-cost, thin metal layer in the vapor deposition plating method described in (4) and (5) above, but a problem is involved therein such that the stability of adhesion between the plastic film and the coating metal layer is significantly inferior compared to other methods.

Means proposed for overcoming this problem of significantly inferior stability of adhesion between the plastic film and the coating metal layer include a method whereby the surface of the plastic film (polyimide film) is modified by plasma treatment prior to vapor deposition plating of the metal layer onto the plastic film (see Journal of the Vacuum Society of Japan, Vol. 39, No. 1 (1996)), for example), and a method whereby the plastic film is dipped in advance in an alcohol solution of a coupling agent, and the surface of the plastic film is modified, after which the metal layer is formed by vapor deposition plating (see JP-A 2002-4067, for example).

### SUMMARY OF THE INVENTION

In the method described in (1) above for bonding a copper foil with a plastic film using an adhesive, since the stability of adhesion between the copper foil and the plastic film is low at high temperature, this method has a problem that the prescribed chip component cannot be laminated using a soldering material that requires high-temperature bonding.

Productivity is low in the casting method described in (2) above due to the difficulty of uniformly etching the metal layer in the latter etching step. When the method for providing a buffer layer is used in conjunction with the lamination method described in (3), two or more types of metal foil are layered. All of these methods ultimately involve complex manufacturing steps, have low productivity, and have high cost.

In the vapor deposition plating method described in (4) above, it has been confirmed, for example, that when plasma treatment is performed for the plastic film prior to vapor deposition plating, the C—C or C—N bond in the ketone group in the polyimide film is broken, and a polar group is formed, which forms an ionic bond with the metal coating, whereby adhesion between the metal film and the polyimide film is enhanced to a certain degree. However, the equipment for plasma treatment is costly, and because a long treatment time is required in order to obtain strong adhesion, a large-scale facility is needed, low productivity is inevitable, and equipment cost is high.

In the vapor deposition plating method described in (5) above, when the plastic film is dipped in advance in an alcohol, aqueous, or other solution of a silicon-containing compound as a coupling agent prior to vapor deposition plating, and the surface of the plastic film is coated and modified with the coupling agent, the surface of the plastic film has an unfavorable coatability, making it difficult to obtain a uniform coating of the coupling agent. Furthermore, since the bonding strength between the plastic film and the coupling agent is low, a practical level of bond strength is not obtained, due to separation of the coupling agent from the plastic film during sputtering and other metal layer vapor deposition processes.

The present invention was contrived in view of the foregoing problems, and an object thereof is to provide a metal-coated substrate having high adhesive stability at high temperature between the metal layer and the plastic film, and in which the thickness of the metal layer can be set to a prescribed thickness; and to provide a method for manufacturing the same.

In order to solve the aforementioned problems, a first aspect of the present invention provides a metal-coated substrate in which a metal layer is provided to one or both sides of a plastic film, wherein the metal layer contains carbon facing towards the metal layer from the joint interface between the plastic film and the metal layer; the content ratio of carbon in the joint interface is 0.7 or greater in the metal layer; and the content ratio of carbon at a depth of 10 nm from the joint interface is 0.1 or greater.

A second aspect of the present invention provides a metal-coated substrate in which a metal layer is provided to one or both sides of a plastic film, wherein the metal layer contains carbon facing towards the metal layer from the joint interface between the plastic film and the metal layer; and the distribution of carbon obtained by measuring the content ratio of carbon to a depth range of 100 nm from the joint interface and integrating the measured values is 5 nm or greater in the metal layer.

A third aspect of the present invention provides the metal-coated substrate according to the first or second aspects, wherein the metal layer contains one or more elements selected from the group consisting of Si, Ti, and Al facing towards the metal layer from the joint interface; and the distribution of at least one element selected from the group consisting of Si, Ti, and Al obtained by measuring the content ratio of at least one element selected from the group consisting of Si, Ti, and Al to a depth range of 100 nm from the joint interface and integrating the measured values is 0.08 nm or greater in the metal layer.

A fourth aspect of the present invention provides the metal-coated substrate according to any of the first through third aspects, comprising a combination of a plastic film layer and a metal layer wherein the difference in the coefficients of linear expansion between the plastic film layer and the metal layer is 15×10⁻⁶/K or less.

A fifth aspect of the present invention provides the metal-coated substrate according to any of the first through fourth aspects, wherein the modulus of elasticity in tension of the plastic film is 1,000 MPa or greater.

A sixth aspect of the present invention provides a method for manufacturing a metal-coated substrate in which a metal layer is provided to one or both sides of a plastic film, comprising applying an organic compound containing one or more elements selected from the group consisting of Si, Ti, and Al to the plastic film; subjecting the plastic film on which the organic compound containing one or more elements selected from the group consisting of Si, Ti, and Al to a heat treatment at 150° C. or higher; and forming a metal layer by a vapor-phase deposition method on the heat-treated plastic film.

A seventh aspect of the present invention provides a method for manufacturing a metal-coated substrate in which a metal layer is provided to one or both sides of a plastic film, comprising simultaneously applying an organic compound containing one or more elements selected from the group consisting of Si, Ti, and Al to the plastic film and heat-treating the film at 150° C. or greater; and forming a metal layer by a vapor-phase deposition method on the heat-treated plastic film.

An eighth aspect of the present invention provides the method for manufacturing a metal-coated substrate according to the sixth or seventh aspects, wherein the step for forming the metal layer by a vapor-phase deposition method is the step for forming a metal layer by sputtering.

A ninth aspect of the present invention provides the method for manufacturing a metal-coated substrate according to any of the sixth through eighth aspects, further comprising forming a metal layer by plating on the metal layer formed by the vapor-phase deposition method.

A tenth aspect of the present invention provides the method for manufacturing a metal-coated substrate according to any of the sixth through ninth aspects, further comprising forming a prescribed circuit pattern in the metal layer by etching the metal layer after the metal film is formed by a vapor-phase deposition method, or after the metal layer is formed by plating.

An eleventh aspect of the present invention provides the method for manufacturing a metal-coated substrate according to any of the sixth through tenth aspects, further comprising forming a prescribed circuit pattern in the metal layer by forming a prescribed circuit pattern in a resist film on the metal film formed by a vapor-phase deposition method, forming a metal layer by plating, peeling off the resist film, and removing the metal layer under the resist film by etching.

The metal-coated substrate according to any of the first through third aspects has high adhesive stability at high temperature between the plastic film and the metal layer, and a metal-coated substrate having the desired thickness and high adhesive stability at high temperature can therefore be obtained by forming a metal layer having the desired thickness on the metal layer by a plating method, for example.

Since the difference in the coefficients of linear expansion between the metal layer and the plastic film in the metal-coated substrate according to the fourth aspects is 15×10⁻⁶/K or less, the metal-coated substrate has excellent dimensional stability.

Since the modulus of elasticity in tension of the plastic film is 1,000 MPa or greater in the metal-coated substrate according to the fifth aspects, the metal-coated substrate has excellent mechanical strength.

With the method for manufacturing a metal-coated substrate according to any of the sixth through eighth aspects, a metal-coated substrate having high adhesive stability at high temperature between the plastic film and the metal layer can be manufactured with good productivity.

With the method for manufacturing a metal-coated substrate according to the ninth means, a metal-coated substrate that has high adhesive stability at high temperature between the plastic film and the metal layer, and is provided with a metal layer having a prescribed thickness can be manufactured with good productivity.

With the method for manufacturing a metal-coated substrate according to the tenth or eleventh aspects, a metal-coated substrate that has high adhesive stability at high temperature between the plastic film and the metal layer, and is provided with a metal layer having a prescribed thickness and a circuit pattern can be manufactured with good productivity.

### BRIEF DESCRIPTION OF THE DRAWINGS

FIG. 1 is a cross-sectional view of the metal-coated substrate of Example 1 in which a metal layer is provided to one side thereof;

FIG. 2 is a cross-sectional view of the metal-coated substrate according to another embodiment of Example 1 in which a metal layer is provided to both sides thereof;

FIG. 3 is a diagram showing the device for applying the coupling agent to the plastic film when the metal-coated substrate of the present invention is manufactured;

FIG. 4 is a diagram showing the content ratio of each component in the depth direction of the copper layer from the interface between the metal layer and the plastic layer in the metal-coated substrate of Example 1;

FIG. 5 is a diagram showing a magnified view of the content ratio of each component in the depth direction of the copper layer from the interface between the metal layer and the plastic layer in the metal-coated substrate of Example 1;

FIG. 6 is a diagram showing the content ratio of each component in the depth direction of the copper layer from the interface between the metal layer and the plastic layer in the metal-coated substrate of Example 2;

FIG. 7 is a diagram showing a magnified view of the content ratio of each component in the depth direction of the copper layer from the interface between the metal layer and the plastic layer in the metal-coated substrate of Example 2;

FIG. 8 is a diagram showing the content ratio of each component in the depth direction of the copper layer from the interface between the metal layer and the plastic layer in the metal-coated substrate of Comparative Example 2;

FIG. 9 is a diagram showing a magnified view of the content ratio of each component in the depth direction of the copper layer from the interface between the metal layer and the plastic layer in the metal-coated substrate of Comparative Example 2;

FIG. 10 is a diagram showing the content ratio of each component in the depth direction of the copper layer from the interface between the metal layer and the plastic layer in the metal-coated substrate of Comparative Example 3;

FIG. 11 is a diagram showing a magnified view of the content ratio of each component in the depth direction of the copper layer from the interface between the metal layer and the plastic layer in the metal-coated substrate of Comparative Example 3;

FIG. 12 is a diagram showing the content ratio of each component in the depth direction of the plastic layer from the interface between the metal layer and the plastic layer in the metal-coated substrate of Example 1;

FIG. 13 is a diagram showing a magnified view of the content ratio of each component in the depth direction of the plastic layer from the interface between the metal layer and the plastic layer in the metal-coated substrate of Example 1;

FIG. 14 is a diagram showing the content ratio of each component in the depth direction of the plastic layer from the interface between the metal layer and the plastic layer in the metal-coated substrate of Example 2;

FIG. 15 is a diagram showing a magnified view of the content ratio of each component in the depth direction of the plastic layer from the interface between the metal layer and the plastic layer in the metal-coated substrate of Example 2;

FIG. 16 is a diagram showing the content ratio of each component in the depth direction of the plastic layer from the interface between the metal layer and the plastic layer in the metal-coated substrate of Comparative Example 2;

FIG. 17 is a diagram showing a magnified view of the content ratio of each component in the depth direction of the plastic layer from the interface between the metal layer and the plastic layer in the metal-coated substrate of Comparative Example 2;

FIG. 18 is a diagram showing the content ratio of each component in the depth direction of the plastic layer from the interface between the metal layer and the plastic layer in the metal-coated substrate of Comparative Example 3; and

FIG. 19 is a diagram showing a magnified view of the content ratio of each component in the depth direction of the plastic layer from the interface between the metal layer and the plastic layer in the metal-coated substrate of Comparative Example 3.

### DESCRIPTION OF THE PREFERRED EMBODIMENTS

Embodiments of the present invention will be described hereinafter with reference to the drawings.

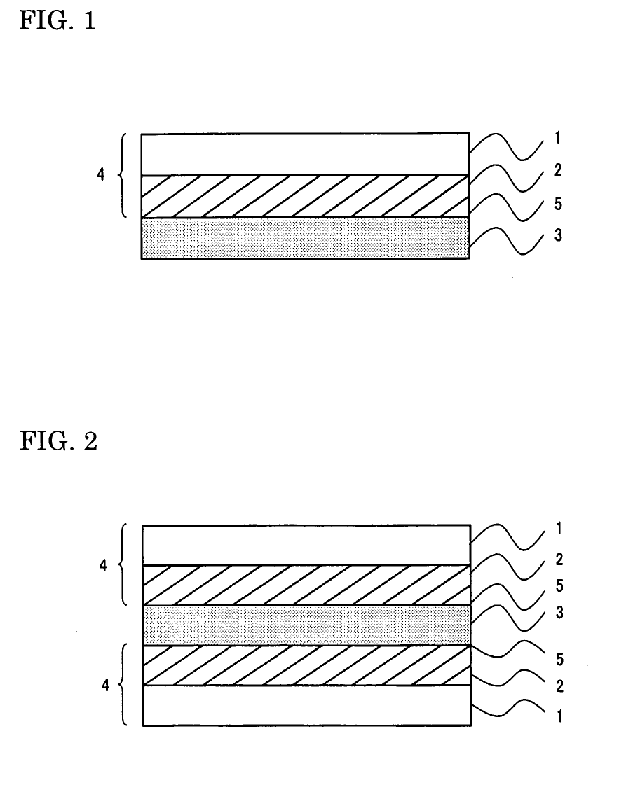

FIG. 1 is a schematic cross-sectional view of a metal-coated substrate according to the present embodiment, which is a type of substrate in which a metal layer is layered on one side of a plastic film. FIG. 2 is a schematic cross-sectional view of a type of substrate in which a metal layer is layered on both sides of a plastic film. First, in FIG. 1, a metal layer 4 is provided via a joint interface 5 on a plastic film 3 as a base. This metal layer 4 has an underlying metal layer 2 (sometimes referred to hereinafter as seed layer 2) continuing from the joint interface, and an overlying metal layer 1 (sometimes referred to hereinafter as plating layer 1) continuing to the underlying metal layer.

In FIG. 2, metal layers 4 are provided via the joint interface 5 to both sides of the base plastic film 3. A seed layer 2 and a plating layer are also provided in each of these metal layers 4 in the same manner as in FIG. 1.

The metal-coated substrate according to the present embodiment is a metal-coated substrate in which the content ratio of carbon in the joint interface in the metal layer is 0.7 or greater as measured at prescribed intervals in the depth direction towards the metal layer side from the joint interface 5 between the plastic film 3 and the metal layer 4, and in which the content ratio of carbon is 0.1 or greater at a depth of 10 nm from the joint interface. The metal-coated substrate is also a metal-coated substrate in which the distribution of carbon is 5 nm or greater as evaluated by measuring the content ratio of carbon at prescribed intervals in the depth direction towards the metal layer side from the joint interface 5 between the plastic film 3 and the metal layer 4, and integrating the measured value of the content ratio in a depth range of up to 100 nm, in which the carbon can be substantially confirmed as measured values. The metal-coated substrate more preferably has an distribution of Si or the like of 0.08 nm or greater as obtained by measuring the content ratio of one or more types of elements (hereinafter referred to as Si or the like) selected from the group consisting of Si, Ti, and Al at prescribed intervals in the depth direction towards the metal layer side from the joint interface 5 in the same manner as in the measurement of carbon, and integrating the content ratio of Si or the like in a depth range of up to 100 nm.

The method of measuring the content ratio or distribution of carbon and Si or the like in the metal layer 4 will first be described with reference to the drawings.

In FIG. 1, after the metal-coated substrate described above was manufactured, the metal layer 4 was peeled at the joint interface 5 with the plastic film 3. After this peeling, the content ratios of the component elements of the etched portion of the peeled face (originally the face constituting the joint interface 5) of the metal layer 4 were sequentially measured by a photoelectron spectroscope while the peeled face was sputter etched in the depth direction. An ESCA PHI 5800 (X-ray source: Al Monochromator X-ray (150 W); analysis area: 800 μm diameter; photoelectron acceptance angle: 45°) manufactured by ULVAC-PHI, Inc. was used as the photoelectron spectroscope. The rate (etching distance) during sputter etching was set to an energy (voltage: 4 kV; current between electrons: 25 mA) whereby a SiO₂ layer could be etched at 5-nm intervals, and sputter etching was performed by the sequential application of this energy.

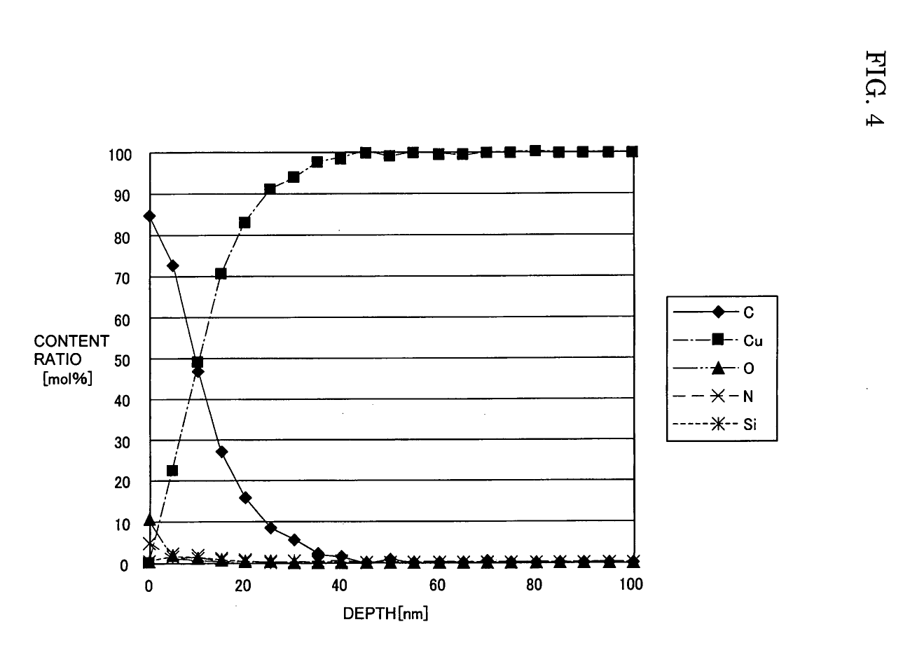

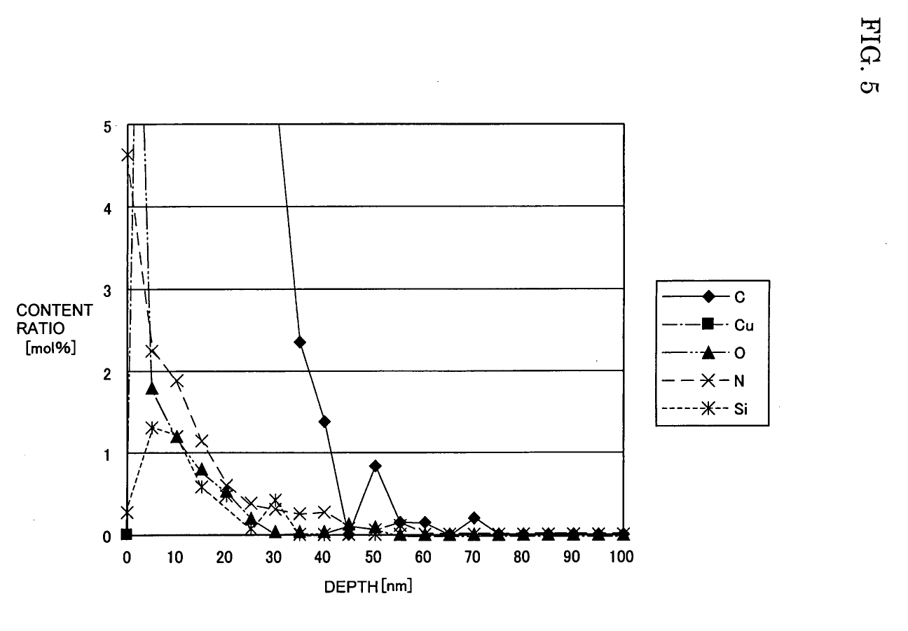

The results will be described using FIGS. 4 and 5.

FIG. 4 shows the results when the content ratios of component elements after each etching were measured by a photoelectron spectroscope while the peeled face of the metal layer in the metal-coated substrate according to Example 1 described hereinafter was sequentially sputter etched in the depth direction. In FIG. 4, the horizontal axis shows, in nanometers, the etched depth (hereinafter referred to as the etched depth) from the peeled face in terms of SiO₂, and the vertical axis shows the content ratio of each element, expressed in percent molar ratio. The content ratios of each of the elements carbon, Cu, O, N, and Si at various etched depths are plotted using a solid line for carbon, a dashed line for Cu, a double-dashed line for O, a triple-dashed line for N, and a dotted line for Si. FIG. 5 shows a portion of FIG. 4 in which the vertical axis is magnified by a factor of 20.

In the measurement of each element by photoelectron spectroscopy, the peeled face was etched to the depth at which the presence of carbon could no longer be substantially confirmed, and the maximum depth was 100 nm.

The method of integrating the measurement results of FIG. 4 and calculating the distribution of carbon and other elements will next be described.

First, when the distribution of carbon was calculated, the content ratio of carbon was measured at minute intervals in the etched depth direction to a depth range of 100 nm, at which the presence of carbon could be substantially confirmed. The value obtained by integrating the measured values is indicated in FIG. 4 by the area enclosed by the vertical and horizontal axes and the line connecting the plotted measurement points of the content ratio of carbon. Specifically, in FIG. 4, the area enclosed by the vertical and horizontal axes and the line connecting the plotted measurement points of the content ratio of carbon was considered to be an indicator of the distribution of carbon at a depth of 100 nm in the depth direction from the peeled face (joint interface). This area was defined as the carbon distribution (Dc) nm.

The content ratios of Si and the like were also measured at minute intervals in the etched depth direction to a range of 100 nm in the depth direction from the peeled face (joint interface), in the same manner as the content ratio of carbon. The value obtained by integrating the measured values is indicated in FIGS. 4 and 5 by the area enclosed by the vertical and horizontal axes and the line connecting the plotted measurement points of the content ratios of Si and the like. Specifically, in FIGS. 4 and 5, the area enclosed by the vertical and horizontal axes and the line connecting the plotted measurement points for Si and the like was considered to be an indicator of the distribution of Si and the like at a depth of 100 nm in the depth direction from the peeled face (joint interface). This area was defined as the distribution (Ds) nm of Si and the like.

Returning to FIGS. 1 and 2, the results of a trial production study into the relationship between the distribution of carbon as well as Si and the like and the bond strength and stability between the metal layer 4 and the plastic film 3 will be described.

It was learned from the trial production study that the bond strength between the metal layer 4 and the plastic film 3 exceeds 0.6 N/mm and is the desirable strength when the metal layer 4 contains carbon facing towards the metal layer side from the joint interface 5 between the plastic film 3 and the metal layer 4, the content ratio of carbon in the joint interface 5 is 0.7 or greater, and the content ratio of carbon at a depth of 10 nm from the joint interface 5 is 0.1 or greater. This bond strength of 0.6 N/mm is the value defined as the bond strength which should be satisfied by a metal-coated substrate for COF applications in the JPCA specification (JACA-BM03-2003) stipulated by the Japan Printed Circuit Association. A metal-coated substrate in which the content ratio of carbon in the joint interface 5 is 0.7 or greater, and the content ratio of carbon at a depth of 10 nm from the joint interface 5 is 0.1 or greater, was therefore found to have adequate bond strength as a metal-coated substrate for use in COF applications.

It was also learned that even when carbon is present at a distribution of 5 nm or greater to a depth range of 100 nm towards the metal layer side from the joint interface 5 between the plastic film 3 and the metal layer 4, the bond strength between the metal layer 4 and the plastic film 3 exceeds 0.6 N/mm, and the desired strength is obtained. A metal-coated substrate in which carbon is present at a distribution of 5 nm or greater towards the metal layer side from the joint interface 5 between the metal layer 4 and the plastic film 3 was therefore found to have adequate bond strength as a metal-coated substrate for use in COF applications.

It was also learned that bond strength is further increased and is preferred when Si and the like is present in a distribution of 0.08 nm or greater in the corresponding portion.

It is not specifically known why the strength and stability of adhesion between the metal layer 4 and the plastic film 3 is markedly enhanced when the content ratio of carbon in the joint interface 5 is 0.7 or greater, and the content ratio of carbon at a depth of 10 nm from the joint interface 5 is 0.1 or greater in the metal layer 4, or when the carbon distribution towards the metal layer side from the joint interface between the plastic film 3 and the seed layer 2 is 5 nm or greater, or Si and the like are present in a distribution of 0.08 nm or greater. A possible general explanation for this phenomenon is given below.

Specifically, carbon present in the seed layer 2 in the metal layer 4 is covalently bonded with each other. Carbon in the seed layer 2 in the vicinity of the joint interface 5 is also covalently bonded with carbon present in the plastic film 3. As a result, strong bonding occurs between carbon in the plastic film 3 and carbon present in the seed layer 2. It is believed that since the carbon and the metal element form an integral structure in the seed layer 2, the strength and stability of adhesion between the plastic film 3 and the seed layer 2, and also the metal layer 4 are significantly enhanced.

It is also believed that since the Si and other elements also generally have good bonding properties with both carbon and metals, these Si and other elements become an intermediary between the seed layer 2 and the plastic film 3, and the strength and stability of adhesion between the metal layer 4 and the plastic film 3 are further enhanced.

An example of the method for manufacturing the metal-coated substrate according to the present embodiment will next be described.

First, a plastic film having heat resistance of 100° C. or higher is prepared. The plastic film is then placed in a heating furnace and heat-dried at 150° C. to 300° C. while passing dried nitrogen gas through the heating furnace. While heating of the plastic film is continued at 150° C. to 400° C., an organic compound containing one or more elements selected from the group consisting of Si, Ti, and Al formed into a gas by heating at 150° C. to 400° C. is blown onto the plastic film for a prescribed period of time. The plastic film thus obtained is then cooled to near room temperature while passing the nitrogen gas through the heating furnace.

A simplified version of the method described above may also be used, whereby the plastic film is placed in a heating furnace and heat-dried at 150° C. to 300° C. while passing the nitrogen gas through the heating furnace. Meanwhile, an organic compound containing one or more elements selected from the group consisting of Si, Ti, and Al formed into a gas by heating at 150° C. to 400° C. is simultaneously blown onto the plastic film. The plastic film thus obtained is then cooled to near room temperature while passing the nitrogen gas through the heating furnace.

A seed layer as an underlying metal layer is formed by a vapor-phase deposition method on the plastic film coated with the organic compound containing Si and the like created by the method described above. Sputtering and ion plating are preferred among vapor-phase deposition methods as the method for coating the seed layer, since these methods produce a high degree of adhesion between the plastic film and the seed layer. The film thus formed preferably has a thickness of 1,000 Å or greater.

A configuration may then be employed for forming a plating layer as an overlying metal layer to a prescribed thickness by electroplating or electroless plating on the seed layer on the plastic film formed using the vapor-phase deposition method. By forming a plating layer using this plating method, it becomes possible to manufacture a metal-coated substrate having the desired thickness with good productivity.

The bond strength between the seed layer and the plastic film can be increased by performing one or more types of pretreatments selected from etching the plastic film in advance using hot alkali, adding a functional group to the surface of the thermoplastic film using a thermoplastic film as the plastic film, and roughening the plastic film as pretreatments performed as needed prior to formation of the seed layer.

A plastic film is preferred in which the difference in the coefficient of linear expansion with respect to the metal in the metal layer that includes the coated seed layer and plating layer is 15×10⁻⁶/K or less. Since the stress due to thermal history is reduced when a plastic film is used in which this difference in the coefficient of linear expansion is 15×10⁻⁶/K or less, warping is minimized, and dimensional stability in etching and other processes is enhanced.

A plastic film is preferably used that has a modulus of elasticity in tension of 1,000 MPa or greater. This is because the mechanical strength of the plastic film is high when the modulus of elasticity in tension of the film is 1,000 MPa or greater, making it possible to use the metal-coated substrate in the hinge of a mobile telephone or other component in which high folding endurance is needed. Examples of such plastic films include commercially available Kapton (manufactured by Toray/DuPont), Upilex (manufactured by Ube Industries, Ltd.), and other polyimide films, and these plastic films are preferred for their high mechanical strength and high thermal stability.

A configuration is also preferred in which a thermoplastic film is fabricated that has a multilayer structure having a plastic film layer as the base of the plastic film and having a thermoplastic film layer that includes a thermoplastic plastic, instead of using the aforementioned commercially available polyimide films, and the seed layer described above is provided on the thermoplastic film layer.

When this configuration is adopted, a plastic film layer is preferably used as the base plastic film layer in which the difference in the coefficient of linear expansion with respect to the metal layer that includes the seed layer and the plating layer is 15×10⁻⁶/K or less. A treatment for applying a coating of the organic compound containing Si and the like is performed on the thermoplastic film layer, and while the temperature is controlled in a range from 100° C. lower than the glass transition temperature of the thermoplastic film layer to less than the decomposition temperature of the thermoplastic film layer, the seed layer is formed on the layered plastic film by a vapor-phase deposition method, and the seed layer is then coated with a plating layer by plating. This process is preferred because the bond strength between the thermoplastic film and the seed layer can be further increased. By adopting a configuration in this process whereby the aforementioned electrical discharge treatment is performed in advance on the thermoplastic film layer, the bond strength between the thermoplastic film layer and the seed layer can be further increased.

A polyimide film is more preferably selected as the thermoplastic film, and a silane coupling agent having an amino group or isocyanate group, a titanate coupling agent,.an aluminum coupling agent, or a mixture thereof is preferred for use as the organic compound containing one or more elements selected from the group consisting of Si, Ti, and Al. This is because a polyimide film and a coupling agent bond more strongly, and a high degree of adhesion can be obtained.

Copper or phosphor bronze, brass, and other oxidation-resistant alloys and the like having copper as the main phase thereof are preferred from the perspective of cost, workability, and other characteristics as the metal used in the seed layer applied to the thermoplastic film. Aluminum, stainless steel, and the like are also good examples of this metal, although the metal used is not limited to these examples.

A metal-coated substrate having high mechanical strength and high heat resistance is obtained when a polyimide film having a glass transition temperature (Tg) of 180° C. or higher is used as the thermoplastic film. A polyamic acid solution fabricated by reacting substantially equimolar amounts of a diamine component and a tetracarboxylic dianhydride in an organic solvent is preferably used as a precursor of the polyimide film in this case.

The starting materials for manufacturing a polyimide film having a glass transition temperature (Tg) of 180° C. or higher will next be described.

Examples of the tetracarboxylic dianhydride include pyromellitic dianhydride, oxydiphthalic dianhydride, biphenyl-3,4,3′,4′-tetracarboxylic dianhydride, biphenyl-2,3,3′,4′-tetracarboxylic dianhydride, benzophenone-3,4,3′,4′-tetracarboxylic dianhydride, diphenylsulfone-3,4,3′,4′-tetracarboxylic dianhydride, 4,4′-(2,2-hexafluoroisopropylidene)diphthalic dianhydride, m(p)-terphenyl-3,4,3′,4′-tetracarboxylic dianhydride, cyclobutane-1,2,3,4-tetracarboxylic dianhydride, 1-carboxymethyl-2,3,5-cyclopentane tricarboxylic acid-2,6:3,5-dianhydride, 2,2-bis(3,4-dicarboxyphenyl)propane dianhydride, bis(3,4-dicarboxyphenyl)ether dianhydride, bis(3, 4-dicarboxyphenyl)sulfone dianhydride, 2,3,6,7-naphthalene tetracarboxylic dianhydride, and the like. Mixtures of two or more types selected from these compounds may also be used, but these examples are not limiting.

Examples of the diamine component include 1,4-diaminobenzene, 1,3-diaminobenzene, 2,4-diaminotoluene, 4,4′-diaminodiphenyl methane, 4,4′-diaminodiphenyl ether, 3,4′-diaminodiphenyl ether, 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,7-diaminodimethyldibenzothiophen-5,5-dioxide, 4,4′-diaminobenzophenone, 3,3′-diaminobenzophenone, 4,4′-bis(4-aminophenyl)sulfide, 4,4′-bis(4-aminophenyl)diphenylmethane, 4,4′-bis(4-aminophenyl)diphenyl ether, 4,4′-bis(4-aminophenyl)diphenyl sulfone, 4,4′-bis(4-aminophenyl)diphenyl sulfide, 4,4′-bis(4-aminophenoxy)diphenyl ether, 4,4′-bis(4-aminophenoxy)diphenyl sulfone, 4,4′-bis(4-aminophenoxy)diphenyl sulfide, 4,4′-bis(4-aminophenoxy)diphenyl methane, 4,4′-diaminodiphenyl sulfone, 4,4′-diaminodiphenyl sulfide, 4,4′-diaminobenzanilide, 1,n-bis(4-aminophenoxy)alkanes (n=3, 4, and 5), 1,3-bis(4-aminophenoxy)-2,2-dimethyl propane, 1,2-bis[2-(4-aminophenoxy)ethoxy]ethane, 9,9-bis(4-aminophenyl)fluorene, 5(6)-amino-1-(4-aminomethyl)-1,3,3-trimethyl indane, 1,4-bis(4-aminophenoxy)benzene, 1,3-bis(4-aminophenoxy)benzene, 1,3-bis(3-aminophenoxy)benzene, 4,4′-bis(4-aminophenoxy)biphenyl, 4,4′-bis(3-aminophenoxy)biphenyl, 2,2-bis(4-aminophenoxyphenyl)propane, 2,2-bis(4-aminophenyl)propane, bis[4-(4-aminophenoxy)phenyl]sulfone, bis[4-(3-aminophenoxy)phenyl]sulfone, 2,2-bis[4-(aminophenoxy)phenyl]propane, 2,2-bis[4-(4-aminophenoxy)phenyl]hexafluoropropane, 3,3′-dicarboxy-4,4′-diaminodiphenyl methane, 4,6-dihydroxy-1,3-phenylenediamine, 3,3′-dihydroxy-4,4′-diaminobiphenyl, 3,3′,4,4′-tetraaminobiphenyl, 1-amino-3-aminomethyl-3,5,5-trimethyl cyclohexane, 1,3-bis(3-aminopropyl)-1,1,3,3-tetramethyl disiloxane, 1,4-diaminobutane, 1,6-diaminohexane, 1,8-diaminooctane, 1,10-diaminodecane, 1,12-diaminododecane, 2,2′-dimethoxy-4,4′-diaminobenzanilide, 2-methoxy-4,4′-diaminobenzanilide, and other aromatic diamines, aliphatic diamines, xylene diamines, and the like. Mixtures of two or more types selected from these compounds may also be used, but these examples are not limiting.

Examples of organic solvents that are suitable for use in manufacturing the polyamic acid include N-methyl-2-pyrrolidone, N,N-dimethylformamide, N,N-dimethylacetamide, N,N-diethylacetamide, dimethyl sulfoxide, hexamethyl phosphoramide, N-methyl caprolactam, cresols, and the like. These organic solvents may be used singly or in mixtures of two or more types thereof, but these examples are not limiting.

Suitable cyclizing agents include dicarboxylic anhydrides and mixtures of two or more types of dicarboxylic anhydrides; trimethyl amines, triethyl amines, and other aliphatic tertiary amines; isoquinolines, pyridines, beta picolines, and other heterocyclic tertiary amines and the like; and mixtures of two or more types of these aliphatic tertiary amines or heterocyclic tertiary amines and the like, but these examples are not limiting.

Described next is the difference in the coefficients of linear expansion between the coating metal layer and the plastic film (including the layered plastic film) in the metal-coated substrate of the present invention. This difference is the standard for selecting raw materials for the layer and the film.

A study into the selection of raw materials of the coating metal layer and the plastic film in the metal-coated substrate according to the present invention indicates that a combination for which the difference in the coefficients of linear expansion between these two materials is 15×10⁻⁶/K or less should preferably be selected. Curling of the plastic film during metal coating, or stress that occurs when the metal-coated substrate is heat treated can be reduced by keeping the difference in the coefficients of linear expansion between these two materials at 15×10⁻⁶/K or less. As a result, the thermal stability of the metal-coated substrate can be enhanced, and such a difference is therefore preferred. In an example of such a combination of a metal layer and a plastic film, copper has a coefficient of linear expansion of 16.6×10⁻⁶/K at a temperature of about 300 K when the metal layer is copper. Therefore, a plastic film having a coefficient of linear expansion of 1.6 to 31.6×10⁻⁶/K is preferably selected. By selecting a plastic film having a modulus of elasticity in tension of 1,000 MPa or greater, a highly reliable metal-coated substrate can be obtained.

The term “coefficient of linear expansion” used in the present invention refers to the coefficient of linear expansion measured in the direction (hereinafter referred to as the MD direction) perpendicular to the direction maintained when the precursor is heat treated during manufacture of the plastic film as the plastic film being measured is cooled from 200° C. to 20° C. at a temperature decrease rate of 5° C./minute. The modulus of elasticity in tension is the modulus of elasticity in tension measured according to ASTM D882 in the MD direction of the plastic film.

Combinations of a diamine component and a tetracarboxylic dianhydride suited for manufacturing a layered plastic film having a modulus of elasticity in tension of 1,000 MPa or greater and a coefficient of linear expansion of 10 to 23×10⁻⁶/K include a combination primarily composed of a biphenyl-3,4,3′,4′-tetracarboxylic dianhydride as the tetracarboxylic dianhydride, and 1,4-diaminobenzene as the diamine component. Each of these components preferably contains 50% or more each of the diamine component and the tetracarboxylic dianhydride, and another component may be substituted for one or more types of the aforementioned diamine component and tetracarboxylic dianhydride.

As needed, a prescribed draw treatment may be performed by first applying a polyamic acid or the like to the base film, drying the product to form a self-supporting gel film, and then fixing one end of the film and drawing the film in the longitudinal and transverse directions. The coefficient of linear expansion of this film can be made to approach that of the coating metal.

A configuration is also preferred in which an underlayer is further provided to the joint interface portion in which the aforementioned seed layer and the plastic film are in contact with each other. This configuration will be described hereinafter.

When this underlayer is provided, the underlayer is preferably selected from layers that contain one or more types of metals selected from the group consisting of Cr, Ni, Mo, W, V, Ti, Si, Fe, and Al, for example, or an alloy containing these metals. When a configuration is adopted in which an underlayer is provided, an organic compound containing one or more elements selected from the group consisting of Si, Ti, and Al formed into a gas by heating at 150° C. to 400° C. is blown onto the plastic film while the aforementioned temperature control is performed. The underlayer may then be formed by a vapor-phase deposition method; copper, an alloy such as phosphor bronze, brass, or another alloy primarily composed of copper, or Ni, Fe, Ag, platinum metal, or another metal or alloy containing these metals may be formed into a film on the underlayer, and a seed layer may be formed.

When this configuration is adopted, the high-temperature stability of the adhesion between the seed layer and the plastic film can be further enhanced. The thickness of the metal of the underlayer is preferably set to a range of approximately 10 to 500 Å in order to maintain good etching properties in the later process when a circuit is formed on the metal-coated substrate.

The aforementioned method for applying a metal coating to the surface of the plastic film and manufacturing a metal-coated substrate may be performed in the same manner in the manufacture of the metal-coated substrate shown in FIG. 2, in which a metal coating is applied to both sides of a plastic film. In this case, the metal coating process described above may be performed on one side at a time, or on both sides simultaneously.

### EXAMPLES

The present invention will be described in further detail hereinafter with reference to examples. The metal-coated substrate is sometimes referred to hereinafter as the “copper-clad flexible substrate.”

### Example 1

(1) Coupling Agent Coating Step

An Upilex-S polyimide film (manufactured by Ube Industries) having a thickness of 25 μm was prepared as the base plastic film. This film had a coefficient of linear expansion of 12×10⁻⁶/K and a modulus of elasticity in tension of 9,120 MPa.

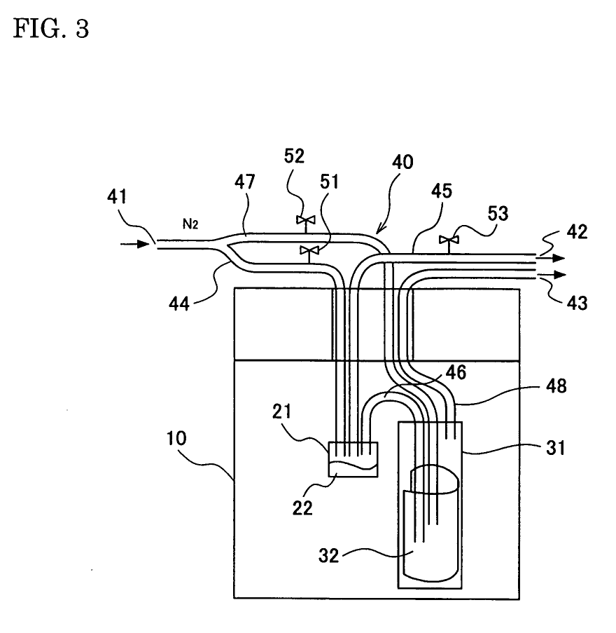

The plastic film was cut to a width of 20 mm and a length of 150 mm and placed in the device shown in FIG. 3 for applying the silane coupling agent as the Si-containing organic compound, and the surface of the plastic film was coated with the coupling agent. In the present example, a silane coupling agent was used as the coupling agent.

In the device for coating the silane coupling agent shown in FIG. 3, a metal container 21 into which the silane coupling agent 22 is charged and a metal container 31 in which the plastic film 32 is accommodated are mounted inside a heating furnace 10. These two metal containers are connected by a heat-resistant hose 40. This hose 40 branches into two hoses 44 and 47 from the hose entrance 41, and one hose 44 is airtightly connected to the metal container 21 via a valve 51. The hoses 45 and 46 are airtightly connected to the metal container 21, the hose 45 leads to the hose exit 42 via a valve 53, and the hose 46 is airtightly connected to the metal container 31. The other hose 47 is also airtightly connected to the metal container 31 via a valve 52. A hose 48 is also airtightly connected to the metal container 31, and leads to the hose exit 43.

First, 5 N pure nitrogen gas used for transport of the coupling agent was introduced at a rate of 5 L/min from the hose entrance 41, valves 51 through 53 were all opened, and the insides of the hose 40 and metal containers 21 and 31 were purged with the nitrogen gas. The valve 51 was then closed while the valves 52 and 53 were left open, the temperature of the heating furnace was increased to 300° C. and maintained for 60 minutes while the nitrogen gas was charged into the metal container 31 at a rate of 5 L/min, and the moisture or volatile organic components in the plastic film 32 were evaporated.

The valves 52 and 53 were then closed while the temperature of the heating furnace was maintained at 300° C., the valve 51 was then opened, and the flow of nitrogen gas was introduced into the metal container 21 containing the silane coupling agent 22. The vaporized silane coupling agent 22 was then transported by the nitrogen gas to the metal container 31 via the hose 46 and blown onto the plastic film 32 for one minute. The valve 51 was then closed, the valves 52 and 53 were opened, the plastic film was cooled to room temperature while nitrogen gas was charged into the metal container 31 at a rate of 5 L/min, and a plastic film coated with the coupling agent was obtained. The amino-based silane coupling agent 3-triethoxysilyl-N-(1,3-dimethyl-butylidene)propylamine (product number KBE-9103, manufactured by Shin-Etsu Chemical Co. (Ltd.)) was used as the silane coupling agent 22.

(2) Sputter Film Formation Step

Copper was formed into a film by sputtering under the conditions below on the surface of the plastic film obtained in (1) coated by the coupling agent.

First, the plastic film was placed in a sputtering device equipped with a copper target so that the surface of the film coated with the coupling agent was facing the target. After the vacuum chamber of the sputtering device was evacuated to 10⁻⁴ Pa, argon gas was introduced, the total pressure was brought to approximately 0.4 Pa, an electrical power of 2 kW was applied, a film of copper having a thickness of 2,000 Å was formed on the plastic film, and a plastic film having a sputtered film was obtained.

(3) Plating Film Formation Step

The resulting plastic film having a sputtered film was plated with a glossy copper coating having a thickness of approximately 6 μm using a plating method, and a copper-clad flexible substrate was created. At this time, a BMP-CUS copper sulfate plating bath manufactured by World Metal Co. (Ltd.) was used as the plating solution, and the current density was set to 1 A/dm².

(4) Evaluation of Etching Properties

After the aforementioned copper-clad flexible substrate was etched at a pattern pitch of 30 μm, and electroless tinning was performed on the etched surface, a voltage of 100 V was applied, the insulation resistance value was measured, and it was found that high insulation resistance values of 10¹¹ Ω and higher were obtained in all of the pattern spaces. It was learned from these results that the etching properties of the copper-clad flexible substrate were good.

(5) Evaluation of Adhesiveness

The copper-clad flexible substrate obtained in (3) above was again plated with a copper metal film to a thickness of 20 μm, and an evaluation sample was obtained. This was because a prescribed strength is necessary in the copper metal film for peel testing in the evaluation of adhesiveness. The bond strength was evaluated according to JIS C6471 by a peel test in the 180° direction at normal temperature and after the evaluation sample was heat-treated for 168 hours at 150° C. The results showed a bond strength of 1.5 N/mm at normal temperature, and 1 N/mm after heat treatment. These results are shown in Table 1.

(6) Evaluation of Joint Interface

In the evaluation of adhesiveness described in (5) above, the content ratios of elements present to an etched depth of 100 nm from the peeled face of the copper metal film layer were measured by a photoelectron spectroscope (ESCA PHI5800, manufactured by ULVAC-PHI) in the evaluation sample peeled at the interface between the plastic film and the copper metal film layer. In this measurement, the content ratios of carbon and Si atoms were measured while a diameter range of 0.8 mm was sputter-etched to a depth of 100 nm in the depth direction of the copper metal film from the joint interface between the plastic film and the copper metal film layer. The results are shown in FIGS. 4 and 5.

The content ratio of carbon in the joint interface was 0.85, and the content ratio of carbon at a depth of 10 nm was 0.47. The carbon distribution (Dc) obtained by integrating the aforementioned content ratios was 11 nm, and the Si distribution (Ds) was 0.21 nm. The above conditions and measured values are shown in Table 1.

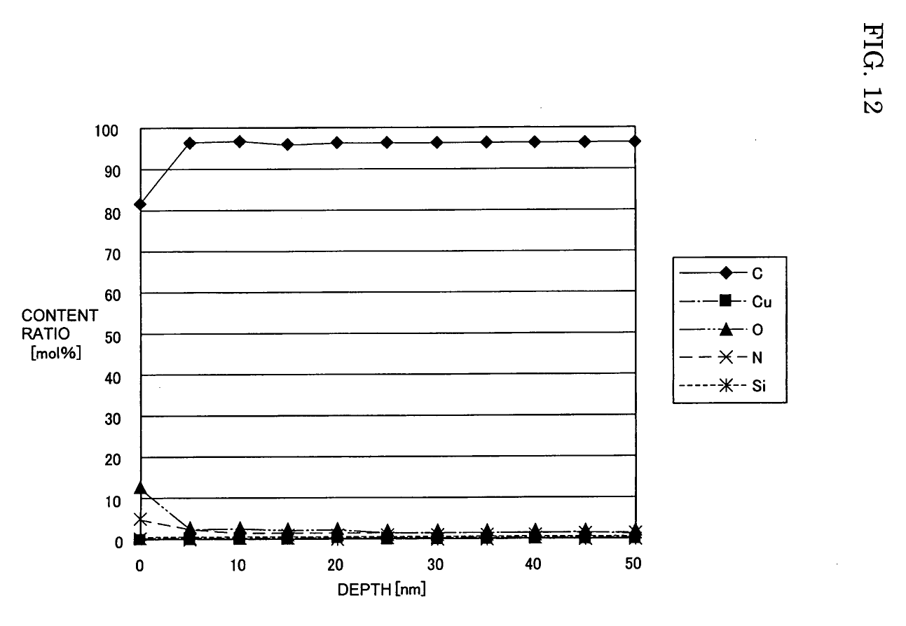

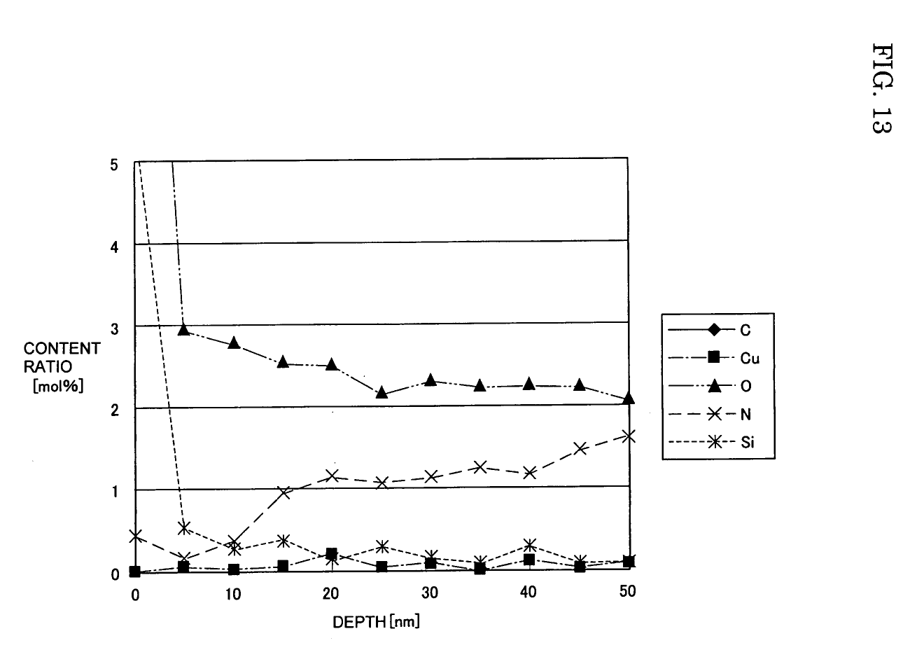

Furthermore, in the evaluation of the joint interface, the content ratios of elements present to an etched depth of 50 nm from the peeled face of the plastic film were measured in the same manner as in the copper metal film while a diameter range of 0.8 mm was sputter-etched to a depth of 50 nm in the depth direction. The results are shown in FIGS. 12 and 13. The vertical and horizontal axes of FIGS. 12 and 13 are the same as those of FIGS. 4 and 5.

The content ratios of carbon, nitrogen, and oxygen atoms at a depth of 5 nm or greater on the plastic film side were approximately the same as the component ratios of the plastic film. The content ratios of nitrogen and oxygen with respect to carbon were somewhat high in the joint interface, but this is considered to be due to adsorption of nitrogen and oxygen on the surface of the plastic film.

### Example 2

(1) Coupling Agent Coating Step

The same plastic film was used for the base as in Example 1, and this film was placed in the same coupling agent coating device as in Example 1 and dried at a temperature of 300° C. for 60 minutes in the same manner as in Example 1.

After the temperature of the heating furnace was set to 200° C., the valves 52 and 53 were closed while the temperature of the heating furnace was maintained, the valve 51 was then opened, and a flow of nitrogen gas was introduced into the metal container 21 containing the silane coupling agent 22. The vaporized silane coupling agent 22 was then transported by the nitrogen gas to the metal container 31 via the hose 46 and blown onto the plastic film 32 for one minute. The valve 51 was then closed, the valves 52 and 53 were opened, the plastic film was cooled to room temperature while nitrogen gas was charged into the metal container 31 at a rate of 5 L/min, and a plastic film coated with the coupling agent was obtained.

The silane coupling agent 22 used was the same as in Example 1.

The sputter film formation step (2), the plating film formation step (3), the evaluation of etching properties (4), the evaluation of adhesiveness (5), and the evaluation of the joint interface (6) were performed in the same manner as in Example 1.

It was learned in the evaluation of adhesiveness (5) that the etching properties of the copper-clad flexible substrate were as good as those of Example 1.

The results of the peeling test in the evaluation of adhesiveness showed bond strengths of 1 N/mm at normal temperature and 0.7 N/mm after heat treatment. These results are shown in Table 1.

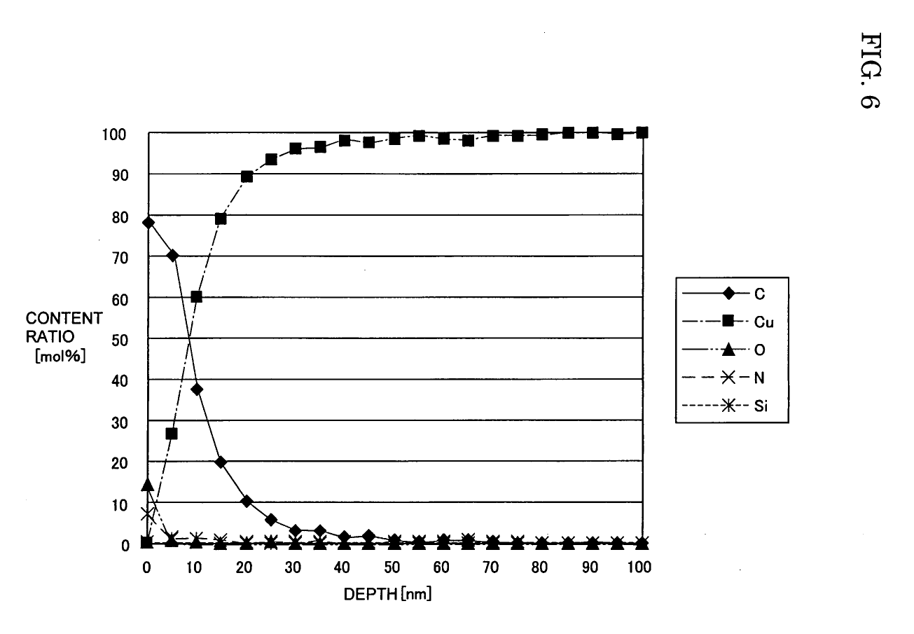

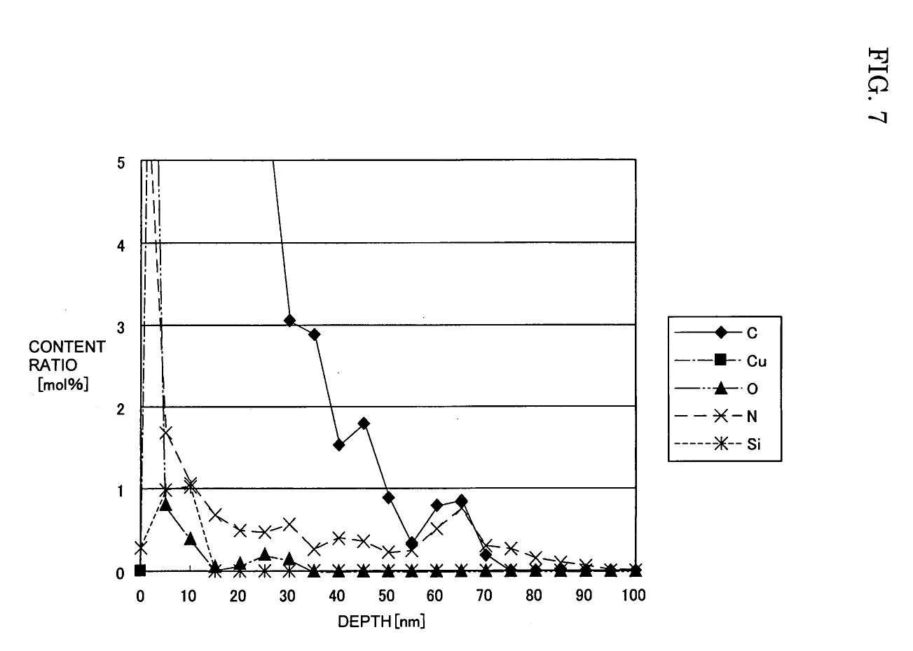

In the evaluation of the joint interface (6), the content ratios of elements present up to an etched depth of 100 nm from the peeled face of the copper metal film layer were measured in the same manner as in Example 1 in the evaluation sample peeled at the interface between the plastic film and the copper metal film layer. The content ratios of carbon and Si atoms were measured while a diameter range of 0.8 mm was etched to a depth of 100 nm in the depth direction of the copper metal film from the joint interface between the plastic film and the copper metal film layer. The results are shown in FIGS. 6 and 7.

The content ratio of carbon in the joint interface was 0.78, and the content ratio of carbon at a depth of 10 nm was 0.38. The carbon distribution (Dc) obtained by integrating the aforementioned content ratios was 9.7 nm, and the Si distribution (Ds) was 0.11 nm. The above conditions and measured values are shown in Table 1.

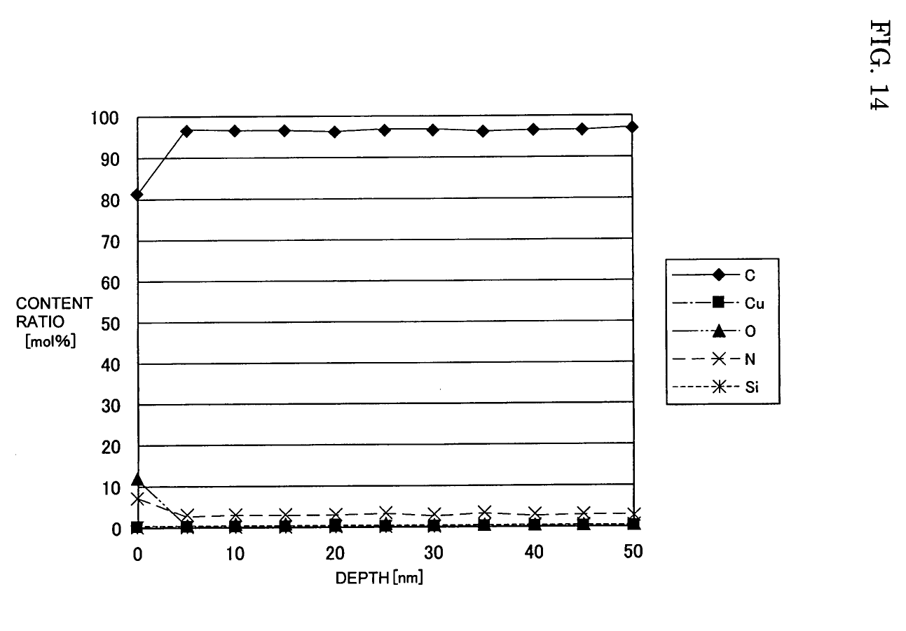

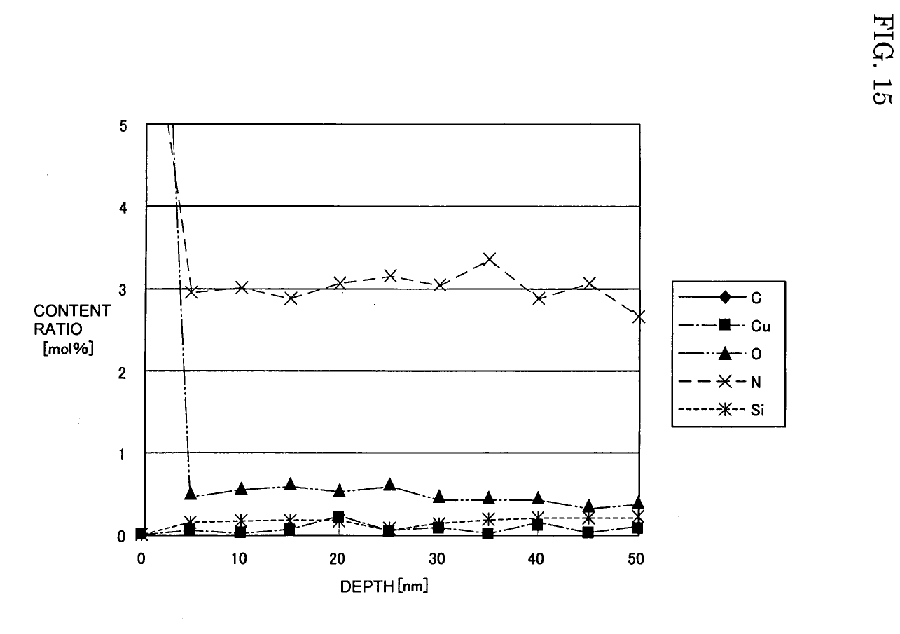

Furthermore, in the evaluation of adhesiveness, the content ratios of elements present to an etched depth of 50 nm from the peeled face of the plastic film were measured in the same manner as in the copper metal film while a diameter range of 0.8 mm was sputter-etched to a depth of 50 nm in the depth direction. The results are shown in FIGS. 14 and 15. The vertical and horizontal axes of FIGS. 14 and 15 are the same as those of FIGS. 4 and 5.

The content ratios of carbon, nitrogen, and oxygen atoms at a depth of 5 nm or greater on the plastic film side were approximately the same as the component ratios of the plastic film. The content ratios of nitrogen and oxygen with respect to carbon were somewhat high in the joint interface. This is considered to be due to adsorption of nitrogen and oxygen on the surface of the plastic film.

### Example 3

(1) Coupling Agent Coating Step

The same plastic film was used for the base as in Example 1, and this film was placed in the same coupling agent coating device as in Example 1 and dried at a temperature of 300° C. for 60 minutes in the same manner as in Example 1.

After the temperature of the heating furnace was set to 150° C., the valves 52 and 53 were closed while the temperature of the heating furnace was maintained, the valve 51 was then opened, and a flow of nitrogen gas was introduced into the metal container 21 containing the silane coupling agent 22. The vaporized silane coupling agent 22 was then transported by the nitrogen gas to the metal container 31 via the hose 46 and blown onto the plastic film 32 for one minute. The valve 51 was then closed, the valves 52 and 53 were opened, the plastic film was cooled to room temperature while nitrogen gas was charged into the metal container 31 at a rate of 5 L/min, and a plastic film coated with the coupling agent was obtained.

The silane coupling agent 22 used was the same as in Example 1.

The sputter film formation step (2), the plating film formation step (3), the evaluation of etching properties (4), the evaluation of adhesiveness (5), and the evaluation of the joint interface (6) were performed in the same manner as in Example 1.

It was learned that the etching properties of the copper-clad flexible substrate were as good as those of Example 1. The results of the peeling test in the evaluation of adhesiveness showed bond strengths of 0.8 N/mm at normal temperature and 0.6 N/mm after heat treatment. These results are shown in Table 1.

The content ratios of carbon and Si atoms were measured while a diameter range of 0.8 mm was sputter-etched to a depth of 100 nm in the depth direction of the plastic film and copper metal film from the joint interface between the plastic film and the copper metal film layer.

The content ratio of carbon in the joint interface was 0.77, and the content ratio of carbon at a depth of 10 nm was 0.16. The carbon distribution (Dc) obtained by integrating the aforementioned content ratios was 5.25 nm, and the Si distribution (Ds) was 0.09 nm. The above conditions and measured values are shown in Table 1.

### Comparative Example 1

(1) Coupling Agent Coating Step

The same plastic film was used for the base as in Example 1, and this film was placed in the same coupling agent coating device as in Example 1 and dried at a temperature of 300° C. for 60 minutes in the same manner as in Example 1.

After the temperature of the heating furnace was set to 100° C., the valves 52 and 53 were closed while the temperature of the heating furnace was maintained, the valve 51 was then opened, and a flow of nitrogen gas was introduced into the metal container 21 containing the silane coupling agent 22. The vaporized silane coupling agent 22 was then transported by the nitrogen gas to the metal container 31 via the hose 46 and blown onto the plastic film 32 for one minute. The valve 51 was then closed, the valves 52 and 53 were opened, the plastic film was cooled to room temperature while nitrogen gas was charged into the metal container 31 at a rate of 5 L/min, and the plastic film coated with the coupling agent was obtained.

The silane coupling agent 22 used was the same as in Example 1.

The sputter film formation step (2), the plating film formation step (3), the evaluation of etching properties (4), the evaluation of adhesiveness (5), and the evaluation of the joint interface (6) were performed in the same manner as in Example 1.

It was learned that the etching properties of the copper-clad flexible substrate were as good as those of Example 1. The results of the peeling test in the evaluation of adhesiveness showed bond strengths of 0.4 N/mm at normal temperature and 0.2 N/mm after heat treatment. These results are shown in Table 1.

The content ratios of carbon and Si were measured while a diameter range of 0.8 mm was sputter-etched to a depth of 35 nm in the depth direction of the plastic film and copper metal film from the joint interface between the plastic film and the copper metal film layer. The distributions of carbon and Si were also obtained using the measured values.

The content ratio of carbon in the joint interface was 0.76, and the content ratio of carbon at a depth of 10 nm was 0.07. The carbon distribution (Dc) obtained by integrating the aforementioned content ratios was 3.62 nm, and the Si distribution (Ds) was 0.06 nm. The above conditions and measured values are shown in Table 1.

### Comparative Example 2

As a comparison with the examples, a sample was fabricated and evaluated by the same method as in Example 1 except that the coupling agent coating step (1) of Example 1 was substituted with a step for applying the coupling agent described below by a wet process.

(1) Coating Step of Coupling Agent by Wet Process

An Upilex-S polyimide film (manufactured by Ube Industries) having a thickness of 25 μm was prepared as the base plastic film. This plastic film was cut to a width of 20 mm and a length of 150 mm. The amino-based silane coupling agent 3-triethoxysilyl-N-(1,3-dimethyl-butylidene)propylamine (product number KBE-9103, manufactured by Shin-Etsu Chemical Co. (Ltd.)) was added in the amount of 1% to a glass vessel containing 300 mL of deionized water, and a silane coupling agent coating solution was obtained. The plastic film was then dipped in this coating solution, the surface of the plastic film was coated with the silane coupling agent, this plastic film coated with the silane coupling agent was placed in a dryer and dried for two hours at a temperature of 100° C., and a coating film of the silane coupling agent was formed on the plastic film.

The sputter film formation step (2), the plating film formation step (3), the evaluation of etching properties (4), the evaluation of adhesiveness (5), and the evaluation of the joint interface (6) were performed in the same manner as in Example 1.

It was learned that the etching properties of the copper-clad flexible substrate were as good as those of Example 1.

The results of the peeling test in the evaluation of adhesiveness showed bond strengths of 0.3 N/mm at normal temperature and 0.1 N/mm after heat treatment. These results are shown in Table 1.

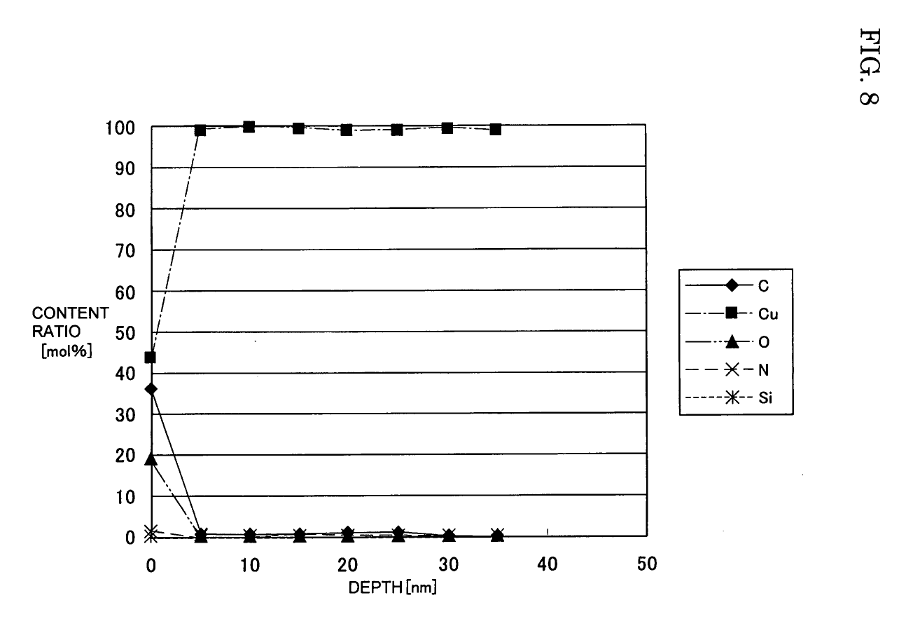

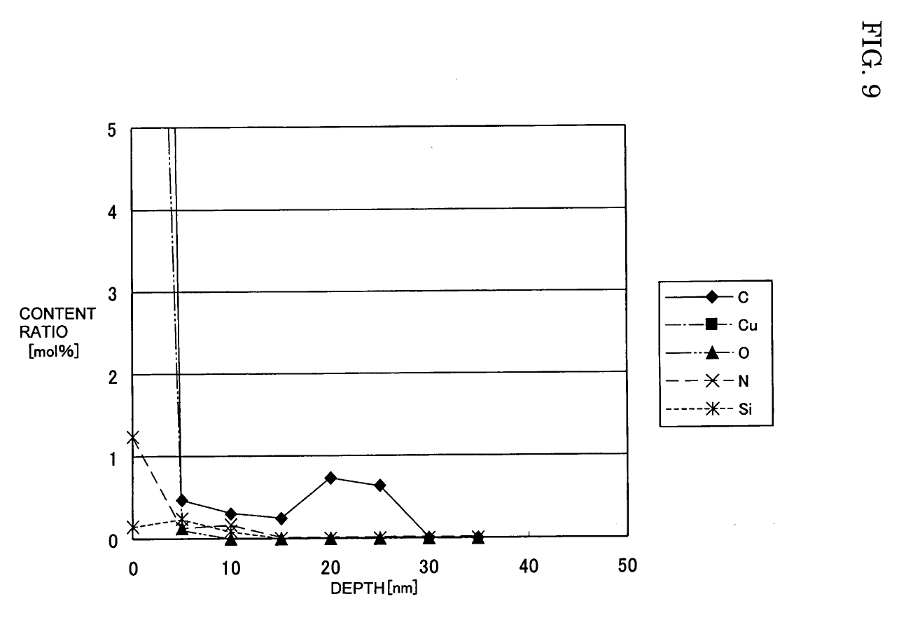

The content ratios of carbon and Si were measured while a diameter range of 0.8 mm was sputter-etched to a depth of 35 nm in the depth direction of the plastic film and copper metal film from the interface between the plastic film and the copper metal film layer. The results are shown in FIGS. 8 and 9. The vertical and horizontal axes of FIGS. 8 and 9 are the same as those of FIGS. 4 and 5. The distributions of carbon and Si were also found using the measured values.

The content ratio of carbon in the joint interface was 0.36, and the content ratio of carbon at a depth of 10 nm was 0.03. The carbon distribution (Dc) obtained by integrating the aforementioned content ratios was 1.1 nm, and the Si distribution (Ds) was 0.02 nm. The above conditions and measured values are shown in Table 1.

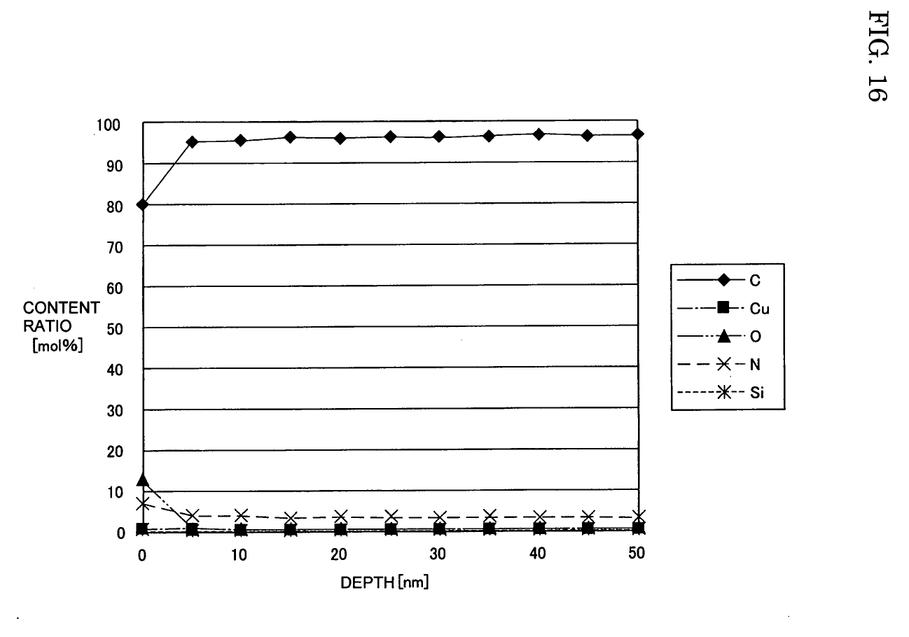

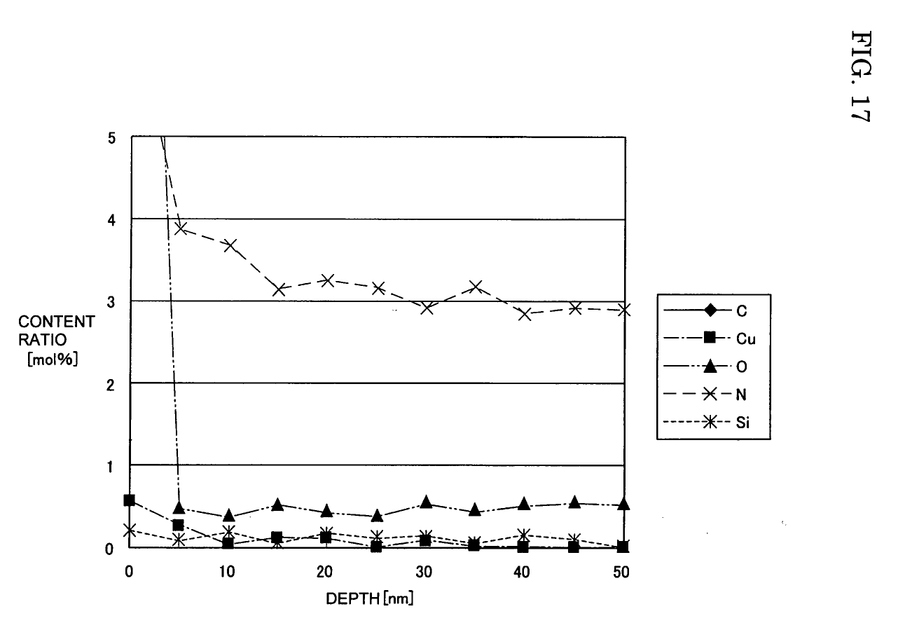

Furthermore, in the evaluation of adhesiveness, the content ratios of elements present to an etched depth of 50 nm from the peeled face of the plastic film were measured in the same manner as in Example 1. (However, since the coupling agent was applied by a wet-process step in Comparative Example 2, the content ratio of silicon was not measured.) The results are shown in FIGS. 16 and 17. The vertical and horizontal axes of FIGS. 16 and 17 are the same as those of FIGS. 4 and 5.

The content ratios of carbon, nitrogen, and oxygen at a depth of 5 nm or greater on the plastic film side were approximately the same as the component ratios of the plastic film. The content ratios of nitrogen and oxygen with respect to carbon were somewhat high in the joint interface. This is considered to be due to adsorption of nitrogen and oxygen on the surface of the plastic film.

### Comparative Example 3

As a comparison with the examples, a sample was fabricated and evaluated by the same method as in Example 1 except that the coupling agent coating step (1) of Example 1 was substituted with the plasma treatment step described below.

(1) Plasma Treatment Step

An Upilex-S polyimide film (manufactured by Ube Industries) having a thickness of 25 μm was prepared as the base plastic film. This plastic film was cut to a width of 20 mm and a length of 150 mm. The plastic film thus cut was then mounted between the electrodes in a vacuum chamber having a pair of electrodes, and the vacuum chamber was evacuated to 10⁻⁴ Pa. In this example, argon gas containing 20% oxygen was introduced, and the total pressure inside the vacuum chamber was brought to approximately 0.05 Pa. An AC power output of 100 W was applied across the electrodes, the plastic film was plasma-treated for one minute, and a plasma-treated plastic film was obtained.

The sputter film formation step (2), the plating film formation step (3), the evaluation of etching properties (4), the evaluation of adhesiveness (5), and the evaluation of the joint interface (6) were performed for the plasma-treated plastic film in the same manner as in Example 1.

It was learned that the etching properties of the copper-clad flexible substrate were as good as those of Example 1.

The results of the peeling test in the evaluation of adhesiveness showed bond strengths of 0.5 N/mm at normal temperature and 0.2 N/mm after heat treatment. These results are shown in Table 1.

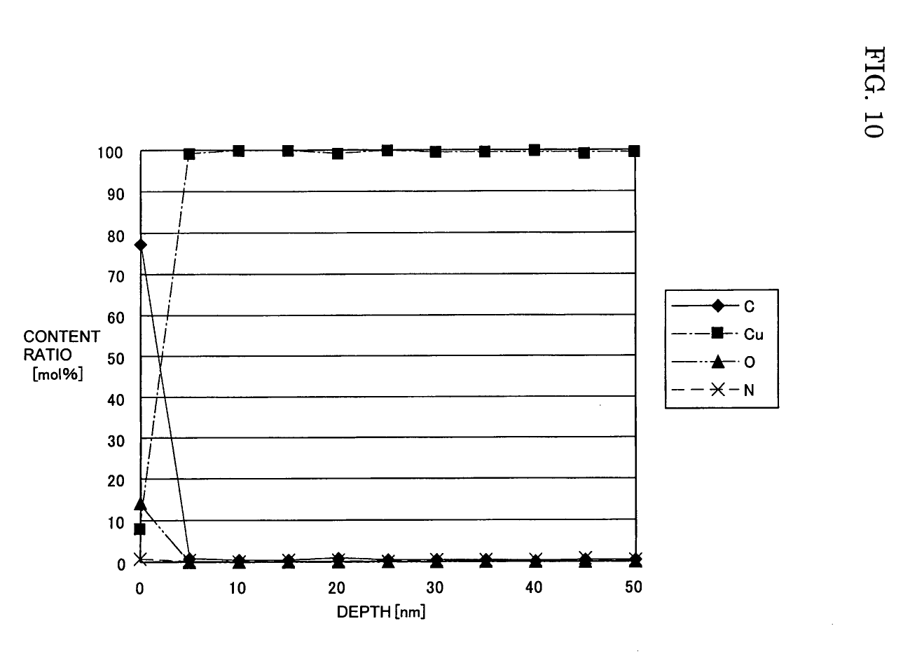

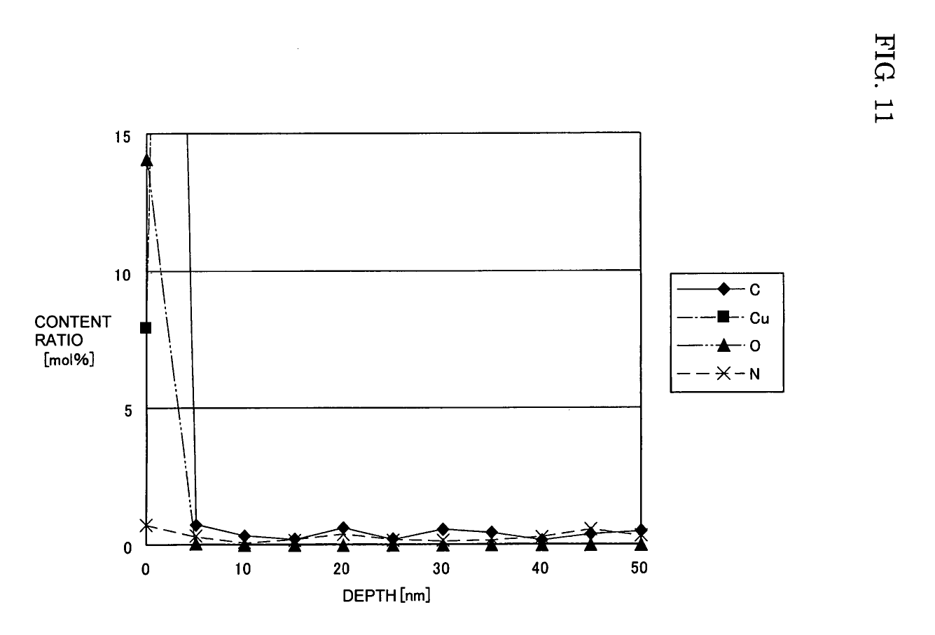

The content ratio of carbon was measured while a diameter range of 0.8 mm was sputter-etched to a depth of 50 nm in the depth direction of the plastic film and copper metal film from the interface between the plastic film and the copper metal film layer. The results are shown in FIGS. 10 and 11. The vertical and horizontal axes of FIGS. 10 and 11 are the same as those of FIGS. 4 and 5. The distribution of carbon was also obtained using the measured values. (Since the plastic film in Comparative Example 3 was not coated with the coupling agent, the content ratio of Si was not measured.)

The content ratio of carbon in the joint interface was 0.77, and the content ratio of carbon at a depth of 10 nm was 0.003. The carbon distribution (Dc) obtained by integrating the aforementioned content ratios was 2.05 nm. The above conditions and measured values are shown in Table 1.

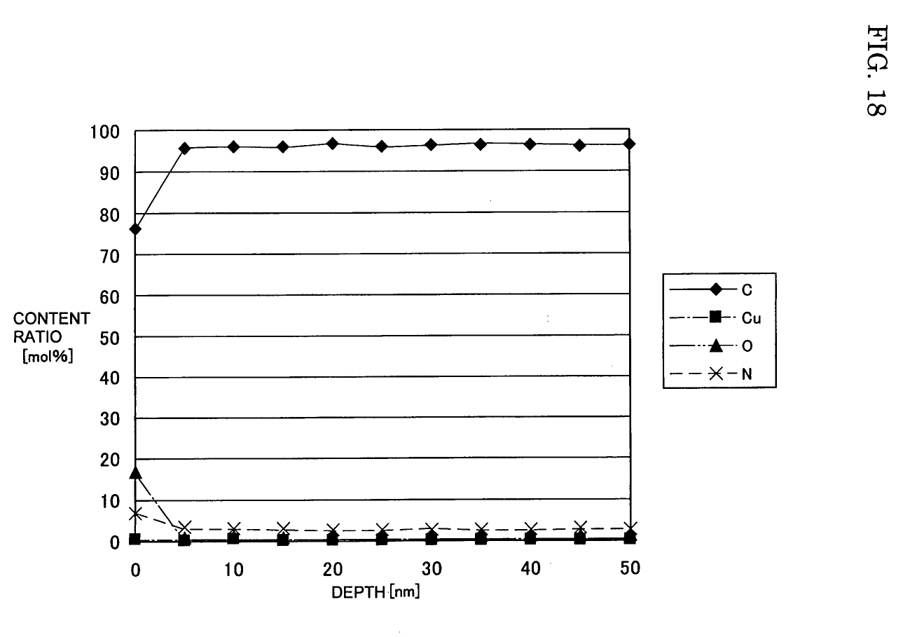

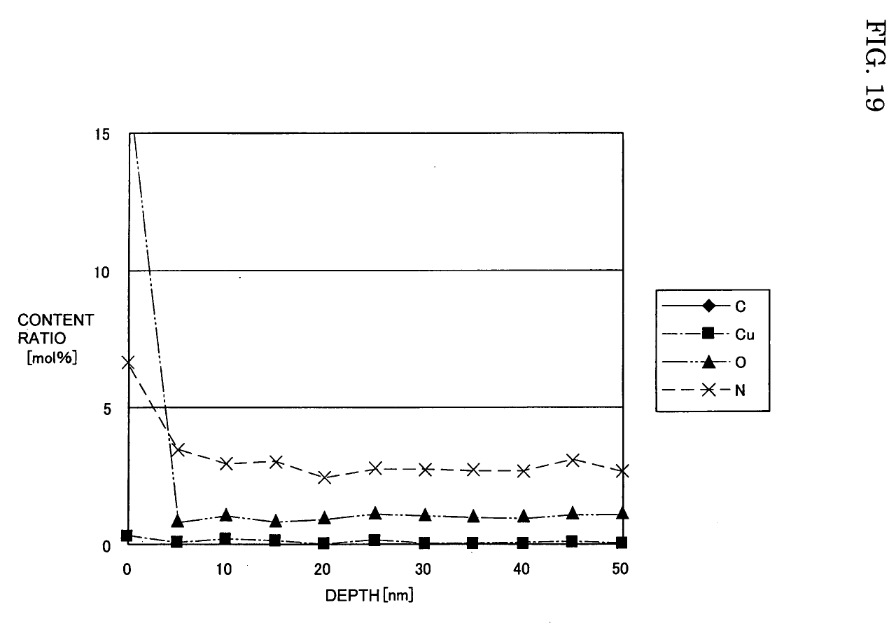

Furthermore, in the evaluation of adhesiveness, the content ratios of elements present to an etched depth of 50 nm from the peeled face of the plastic film were measured in the same manner as in Example 1. (Since the coupling agent was not used in Comparative Example 3, the content ratio of Si was not measured.) The results are shown in FIGS. 18 and 19. The vertical and horizontal axes of FIGS. 18 and 19 are the same as those of FIGS. 4 and 5.

The content ratios of carbon, nitrogen, and oxygen atoms at a depth of 5 nm or greater on the plastic film side were approximately the same as the component ratios of the plastic film. The content ratios of nitrogen and oxygen with respect to carbon were somewhat high in the joint interface. This is considered to be due to adsorption of nitrogen and oxygen on the surface of the plastic film.

### Example 4

(1) Coupling Agent Coating Step

The same coupling agent coating step as in Example 2 was performed, except that the amino-based silane coupling agent 3-triethoxysilyl-N-(1,3-dimethyl-butylidene)propylamine was substituted with the amino-based silane coupling agent 3-aminopropyl trimethoxysilane (product number A-1100, manufactured by Nippon Unicar Co. (Ltd.)) as the silane coupling agent 22.

The sputter film formation step (2), the plating film formation step (3), the evaluation of etching properties (4), the evaluation of adhesiveness (5), and the evaluation of the joint interface (6) were performed in the same manner as in Example 1.

It was learned that the etching properties of the copper-clad flexible substrate were as good as those of Example 2.

The results of the peeling test in the evaluation of adhesiveness showed bond strengths of 0.9 N/mm at normal temperature and 0.6 N/mm after heat treatment. These results are shown in Table 1.

The content ratios of carbon and Si were measured while a diameter range of 0.8 mm was sputter-etched to a depth of 100 nm in the depth direction of the plastic film and copper metal film from the interface between the plastic film and the copper metal film layer.

The content ratio of carbon in the joint interface was 0.78, and the content ratio of carbon at a depth of 10 nm was 0.40. The carbon distribution (Dc) obtained by integrating the aforementioned content ratios was 9.05 nm, and the Si distribution (Ds) was 0.10 nm. The above conditions and measured values are shown in Table 1.

### Example 5

(1) Coupling Agent Coating Step

The same coupling agent coating step as in Example 2 was performed, except that the amino-based silane coupling agent 3-triethoxysilyl-N-(1,3-dimethyl-butylidene)propylamine was substituted with the isocyanate-based silane coupling agent 3-isocyanate propyl trimethoxysilane (product number Y-5187, manufactured by Nippon Unicar Co. (Ltd.)) as the silane coupling agent 22.

The sputter film formation step (2), the plating film formation step (3), the evaluation of etching properties (4), the evaluation of adhesiveness (5), and the evaluation of the joint interface (6) were performed in the same manner as in Example 1.

It was learned that the etching properties of the copper-clad flexible substrate were as good as those of Example 2.

The results of the peeling test in the evaluation of adhesiveness showed bond strengths of 1.1 N/mm at normal temperature and 0.7 N/mm after heat treatment. These results are shown in Table 1.

The content ratios of carbon and Si were measured while a diameter range of 0.8 mm was sputter-etched to a depth of 100 nm in the depth direction of the plastic film and copper metal film from the interface between the plastic film and the copper metal film layer.

The content ratio of carbon in the joint interface was 0.79, and the content ratio of carbon at a depth of 10 nm was 0.39. The carbon distribution (Dc) obtained by integrating the aforementioned content ratios was 9.60 nm, and the Si distribution (Ds) was 0.11 nm. The above conditions and measured values are shown in Table 1.

TABLE 1

| | | | | | | COM- | COM- | | |
|---|---|---|---|---|---|---|---|---|---|
| | | | | | COMPAR- | PAR- | PAR- | | |
| | | | | | ATIVE | ATIVE | ATIVE | | |
| | | EXAMPLE | EXAMPLE | EXAMPLE | EXAMPLE | EXAM- | EXAM- | EXAMPLE | EXAMPLE |
| | | 1 | 2 | 3 | 1 | PLE 2 | PLE 3 | 4 | 5 |
| COATING | COUPLING | KBE-9103 | KBE-9103 | KBE-9103 | KBE-9103 | KBE-9103 | — | A-1100 | Y-5187 |
| STEP | AGENT | | | | | | | | |
| | COATING | GAS | GAS | GAS | GAS | DIPPING | PLASMA | GAS | GAS |
| | METHOD | COATING | COATING | COATING | COATING | | | COATING | COATING |
| | HEAT | 300 | 200 | 150 | 100 | 100 | — | 200 | 200 |
| | TREATMENT | | | | | | | | |
| | TEMPERATURE | | | | | | | | |
| | (° C.) | | | | | | | | |
| ADHESIVENESS | NORMAL | 1.5 | 1 | 0.8 | 0.4 | 0.3 | 0.5 | 0.9 | 1.1 |
| EVALUATION | TEMPERATURE | | | | | | | | |
| | (N/mm) | | | | | | | | |
| | 150° C.168 h | 1 | 0.7 | 0.6 | 0.2 | 0.1 | 0.2 | 0.6 | 0.7 |
| | (N/mm) | | | | | | | | |
| EVALUATION | CONTENT | 0.85 | 0.78 | 0.77 | 0.76 | 0.36 | 0.77 | 0.78 | 0.79 |
| OF JOINT | RATIO | | | | | | | | |
| INTERFACE | OF CARBON | | | | | | | | |
| | IN JOINT | | | | | | | | |
| | INTERFACE | | | | | | | | |
| | CONTENT | 0.47 | 0.38 | 0.16 | 0.07 | 0.03 | 0.003 | 0.40 | 0.39 |
| | RATIO | | | | | | | | |
| | OF CARBON | | | | | | | | |
| | AT DEPTH OF | | | | | | | | |
| | 10 nm | | | | | | | | |
| | CARBON | 11 | 9.7 | 5.25 | 3.62 | 1.1 | 2.05 | 9.05 | 9.6 |
| | DISTRIBUTION | | | | | | | | |
| | (nm) | | | | | | | | |
| | Si | 0.21 | 0.11 | 0.09 | 0.06 | 0.02 | 0.00 | 0.1 | 0.11 |
| | DISTRIBUTION | | | | | | | | |
| | (nm) | | | | | | | | |

1. A metal-coated substrate in which a metal layer is provided to one or both sides of a plastic film, wherein
said metal layer contains carbon facing towards the metal layer from the joint interface between said plastic film and metal layer;
the content ratio of carbon in said joint interface is 0.7 or greater in said metal layer; and
the content ratio of carbon at a depth of 10 nm from said joint interface is 0.1 or greater.

2. A metal-coated substrate in which a metal layer is provided to one or both sides of a plastic film, wherein
said metal layer contains carbon facing towards the metal layer from the joint interface between said plastic film and metal layer; and
the distribution of carbon obtained by measuring the content ratio of carbon to a depth range of 100 nm from said joint interface and integrating said measured values is 5 nm or greater in said metal layer.

3. The metal-coated substrate according to claim 1, wherein
said metal layer contains one or more elements selected from the group consisting of Si, Ti, and Al facing towards the metal layer from said joint interface; and
the distribution of at least one element selected from said group consisting of Si, Ti, and Al obtained by measuring the content ratio of at least one element selected from said group consisting of Si, Ti, and Al to a depth range of 100 nm from said joint interface and integrating said measured values is 0.08 nm or greater in said metal layer.

4. The metal-coated substrate according to claim 1, comprising a combination of a plastic film layer and a metal layer wherein the difference in the coefficients of linear expansion between said plastic film layer and said metal layer is 15×10⁻⁶/K or less.

5. The metal-coated substrate according to claim 1, wherein the modulus of elasticity in tension of said plastic film is 1,000 MPa or greater.

6. A method for manufacturing a metal-coated substrate in which a metal layer is provided to one or both sides of a plastic film, comprising:
applying an organic compound containing one or more elements selected from the group consisting of Si, Ti, and Al to said plastic film;
subjecting the plastic film on which the organic compound containing one or more elements selected from said group consisting of Si, Ti, and Al has been applied to a heat treatment at 150° C. or higher; and
forming a metal layer by a vapor-phase deposition method on said heat-treated plastic film.

7. A method for manufacturing a metal-coated substrate in which a metal layer is provided to one or both sides of a plastic film, comprising:
simultaneously applying an organic compound containing one or more elements selected from the group consisting of Si, Ti, and Al to said plastic film and heat-treating the film at 150° C.; and

8. The method for manufacturing a metal-coated substrate according to claim 6, wherein the step for forming the metal layer by said vapor-phase deposition method is the step of forming a metal layer by sputtering.

9. The method for manufacturing a metal-coated substrate according to claim 6, further comprising forming a metal layer by plating on the metal layer formed by said vapor-phase deposition method.

10. The method for manufacturing a metal-coated substrate according to claim 6, further comprising forming a prescribed circuit pattern in said metal layer by etching said metal layer after the metal film is formed by said vapor-phase deposition method, or after the metal layer is formed by said plating.

11. The method for manufacturing a metal-coated substrate according to claim 6, comprising on a metal film formed by the vapor-phase deposition method:
forming a prescribed circuit pattern by using a resist film;
thereafter forming the metal layer by a plating method;
thereafter peeling off the resist film; and
removing the metal layer under the resist film by etching;
thereby forming the prescribed circuit pattern on the metal layer.
